(19) United States
(12) Patent Application Publication
(10) Pub. No.: US 2004/0122745 A1
(43) Pub. Date: Jun. 24, 2004

(54) Method for aiding consumers in selection of the proper size of interlabial absorbent articles

(75) Inventors: Richard Hantke, Appleton, WI (US); Heather Sorebo, Appleton, WI (US); Aida Flick, Menasha, WI (US)

Correspondence Address: STEPHEN E. BONDURA, ESQ., DORITY & MANNING, P.A., P.O. BOX 1449, GREENVILLE, SC, 29602-1449, US

(73) Assignee: KIMBERLY-CLARK WORLDWIDE, INC.

(21) Appl. No.: 10/325,440

(22) Filed: Dec. 20, 2002

(51) Int. Cl. G06F 17/60

(52) U.S. Cl. 705/27

(57) ABSTRACT

A method and system are provided for aiding consumers in determining the proper size of an interlabial absorbent article product. At least one characteristic factor relating to a physical characteristic or trait of a wearer is correlated with a corresponding product size. The correlated data is arranged in a data format and made available to consumers prior to purchase of the absorbent article product.

### FIELD OF THE INVENTION

The present invention relates to the field of feminine hygiene products, and more particularly to the use of interlabial absorbent articles.

### BACKGROUND

A broad range and wide variety of absorbent articles configured for absorption of bodily exudates such as menstrual fluid are well known. With respect to feminine hygiene, sanitary napkins and panty liners have been developed for external wear about the pudendum region. Tampons have been developed for placement within the vaginal cavity, and accordingly for interruption of menstrual flow therefrom prior to such menstrual flow reaching the vestibule. Hybrid feminine hygiene protection devices, attempting to merge the structural features of both sanitary napkins and tampons in a single type of device, have also been proposed, but have not seen a meaningful measure of acceptance.

Other less intrusive devices, known as interlabial devices or articles, have also been proposed. These articles are designed to reside primarily within the wearer's vestibule while having a portion residing at least partially external of the wearer's vestibule. Interlabial articles can provide a preferred profile or appearance when viewed through a wearer's outer garments and do not have the same problems of reliance on swelling within the vaginal canal as required by tampons. U.S. Pat. Nos. 5,484,429; 4,175,561; 3,983,873; and 3,726,277 disclose various types of interlabial absorbent articles.

Significant factors affecting consumer acceptance of interlabial articles are product comfort, reliability, and ease of use. Each of these factors depends at least in part on the consumer wearing the proper size product. An interlabial pad that is too large may cause discomfort to the consumer. Similarly, an interlabial pad that is too small may perform poorly. Unfortunately, consumers are often unaware of how to properly select between different product sizes to maximize product comfort, reliability, etc., for their particular body type. For many consumers, a “proper” size is determined only after a trial-and-error type of experience with the different size products. Also, there may be inconsistencies or size differences between varying brands or types of products such that a particular size of one product may not be the best size for a different product.

The art is thus in need of an easy and reliable method for aiding consumers in the selection of a best or optimum size of interlabial absorbent article. The present invention provides such a method.

### SUMMARY

Objects and advantages of the invention will be set forth in part in the following description, or may be obvious from the description, or may be learned through practice of the invention. The present invention relates to an information system and method for aiding consumers in selecting the proper size of interlabial absorbent article. The invention is not limited to any particular type or style of interlabial device. The system and method according to the invention may be used by consumers and manufacturers for predicting the proper size article for any manner of interlabial device.

The invention is premised on identifying “factors”, such as physical characteristics or traits of consumers, that influence proper selection between different sized articles. The factors are correlated with product sizes into an easy to read and interpret data format. The format is presented to consumers in any one of a wide variety of media so that the consumer may make an informed decision prior to purchase of the product.

The consumer-specific factors relate generally to physical attributes that virtually every woman knows about herself and which have been determined to affect proper size selection of an interlabial absorbent article. For example, the factors may include any combination of the following: age, weight, body mass index (“BMI”), and number of vaginal births. Another factor may include, for example, panty size, etc. The invention is not limited by the number of types of factors.

The correlation of any particular factor (or variable of the same factor) to a product size may be derived directly or indirectly from empirical data. For example, in a direct method, a relevant female age group may be defined (e.g., ages 12 to 49), and females within this age group sampled and tested for selection of product size based solely on the factor of age. The same procedure may be carried out for the other factors. From the empirically derived data, an information system is derived that easily correlates a particular factor to a particular size product.

In an indirect method, a statistical model may be adapted to a broad sample data set containing representative data points relating to the factors and product sizes. The model may be used to predict the best or preferred product size as a function of any one or combination of the factors. For example, a multi-nominal logistic regression model, or other suitable statistical prediction model, may be used to correlate a particular size product to a particular factor (or different variables of the same factor) from a relatively large sample class. In the case of a probability based on a combination of the factors, such factors may be given different correlation values in the model. For example, the factor of vaginal births is more highly correlated with product size than the factor of age, and the number of vaginal births will thus have a greater impact on product size selection in the model. Certain factors may be given a negative correlation value. For example, age may be given a negative correlation value because, as the age of a woman increases, she is more inclined to choose a smaller size product. Number of vaginal births, weight, and BMI may have positive correlation values.

It should be appreciated that the inventive method and system are not limited to any particular manner of correlating product size to consumer factor(s), and may include direct testing/sampling methods, and indirect methods such as statistical probability models.

The correlated information may be presented to consumers by any suitable method. For example, a table, graph, or chart may be provided with the product packaging so that a potential consumer may refer directly to the package prior to purchase of the product. In another embodiment, the information may be presented in a “remote” manner, such as via a website, pamphlet, video, etc. The information may be made available via an interactive system, for example, an interactive website or kiosk-type terminal at the point of sale of the articles. The particular format for presenting the information is not a limiting factor, but care should be taken to present the correlated data in a format that is easy to use and understand for typical consumers.

Aspects of the invention will be described in greater detail below by reference to embodiments illustrated in the attached drawings.

### BRIEF DESCRIPTION OF THE DRAWINGS

FIG. 1 is a perspective and partial cut-away view of an exemplary interlabial absorbent article.

### DETAILED DESCRIPTION

Reference will now be made in detail to embodiments of the invention, one or more examples of which are illustrated in the drawings. Each embodiment and example are provided for purposes of explaining the invention, and are not meant as a limitation of the invention. For example, features illustrated or described as part of one embodiment may be used with another embodiment to yield still a further embodiment. It is intended that the present invention include these and other modifications and variations as come within the scope and spirit of the invention.

As used herein, the term “interlabial absorbent article” refers to a device having at least one absorbent component, and which is specifically configured for disposition between the labia majora, extending at least partially into the vestibule of a female wearer during use. The vestibule is considered to be the region defined within the labia beginning at about a point lying caudally from the anterior labial commissure and extending rearward to the posterior labial commissure, and bounded inwardly by the floor of the vestibule. An interlabial absorbent article is disposed at least partially within the vestibule for at least partially occluding the vestibule with respect to fluid flow from the vestibule. In this regard, the predominant use of the absorbent article is for the absorption of menstrual fluid emitted via the vaginal orifice, although the article is equally well adapted to serve as a type of incontinence device for absorption of urine as occurs upon minor, female incontinence.

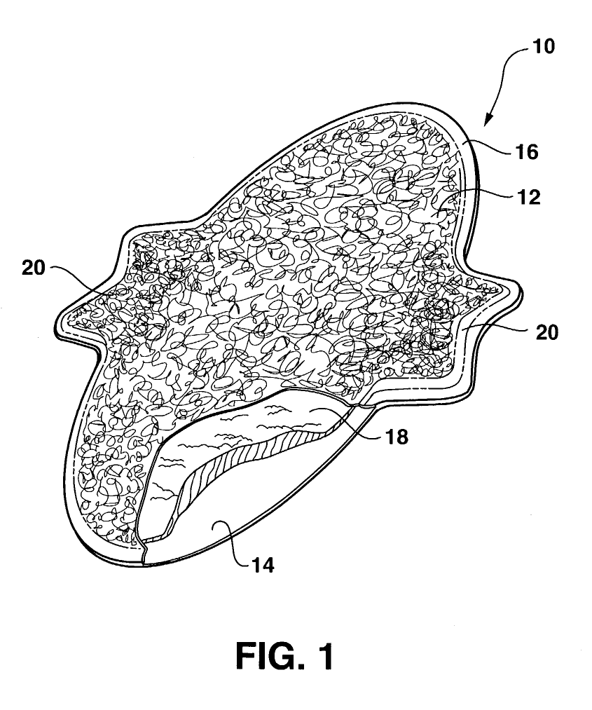

FIG. 1 illustrates an exemplary interlabial absorbent article 10. The absorbent article 10 includes a top sheet 12, a back sheet 14, and an absorbent material 18 sandwiched between the top sheet 12 and back sheet 14. The top sheet 12 and back sheet 14 are sealed together at their edges 16, the sealed edges 16 defining an overall geometry for the article 10. The article 10 should be of a suitable size and shape to allow at least a portion, preferably a major portion, of the absorbent article to be disposed within the vestibule of a female wearer. In addition, the absorbent article 10 desirably at least partially occludes and intercepts the flow of menstrual fluid, urine or other bodily exudates from the wearer's vaginal orifice and/or urethral orifice.

Various constructions and combinations of suitable materials used in interlabial absorbent articles are well know to those skilled in the art and need not be described herein in detail for an appreciation and understanding of the method and system according to the invention.

It should be appreciated that the method and system according to the present invention are not limited to any particular shape or configuration of absorbent article. In the illustrated embodiment, for example, the article 10 has an overall oval shape with laterally extending wing or tab portions 20. Various other suitable shapes are known to those skilled in the art, such shapes being designed for particular purposes. For example, in certain applications, it may be desired that the article 10 have a non-symmetric shape and have, for example, increased absorbency at one end as compared to another.

It should be appreciated that the overall shape and configuration of an article 10 may play a significant role in selection of a particular size product. For example, a “medium” size symmetric oval pad may be the proper size for a particular women whereas a “medium” size rectangular or non-symmetric pad may be too large and result in discomfort to the same wearer.

One of skill in the art fully understands that the “proper” size (with respect to comfort and ease of use) of an interlabial device is a function of the size and shape of the wearer's labia majora and labia minora defining the vestibule contour. However, there is a wide range of variation among women with respect to the relative size and shape of labia majora and labia minora. There is also great variance in the elasticity and dimensions of the labial/vestibule region between women. Vestibule lengths may range from 15-100 mm, and widths may range from 5-50 mm. Such variance is problematic for manufacturers in that it is difficult to provide a single size interlabial article that is comfortable for a wide range of women. Thus, it is common to provide various sizes of particular products. For example, an interlabial absorbent article may be provided in three sizes: small (60 mm long by 66 mm wide at product tabs); medium (80 mm long by 70 mm wide at product tabs); and large (100 mm long by 70 mm wide at product tabs).

Although it would be beneficial to fit or size interlabial articles according to vestibule size or dimensions, this information is not known by most women and is not readily determined absent a thorough physical examination. The system and method of the present invention recognizes that certain inherent physical characteristics, traits, etc. (collectively referred to as “factors”) that are known by virtually every women correlate to product size and may be used as predictors to aid women in selecting a proper size interlabial product. These factors may include, but are not limited to, age, weight, body mass index, and number of vaginal births. Other readily known or easily obtainable factors proven to correlate to interlabial product size may also be used within the scope and spirit of the invention. For example, panty size is a factor known by most women and may be used as a predictor of the appropriate size of interlabial article.

As mentioned, the invention is not limited to any particular method of correlating the factors to particular product sizes. For example, direct correlation from empirical testing may be conducted. However, such method may prove extremely time consuming and require a significant sample class, particularly if all variations of a factor or combination of different factors are to be correlated. For example, it may be desired to hold the factor of age as a constant and sample solely for the effect of weight by increments of ten pounds. To conduct this methodology for an age group of between, for example, 12 to 49 years, would require a tremendous (and likely unattainable) number of test subjects. It may prove beneficial to “indirectly” derive the correlation from a limited sample class by the use of widely accepted statistical probability models. For example, a multinomial logistic regression model may be fit to a sample class using any number of variable factors to predict the effect of any one or combination of the factors on product size. The use of multinomial logit models is well known to statisticians for predicting from a sample data set responses from a set of choices. These models may be fit particularly well to scenarios wherein the independent variables are characteristics of the chooser, not of the choices. In the case of a probability based on a combination of the factors, such factors may be given different correlation values in the model. For example, the factor of vaginal births is more highly correlated with product size than the factor of age, and the number of vaginal births will thus have a greater impact on product size selection in the model. Some factors may be given a negative correlation value. For example, age may be given a negative correlation value because, as the age of a woman increases, she is more inclined to choose a smaller size product. Number of vaginal births, weight, and BMI may have positive correlation values.

In an embodiment of the method and system according to the invention, a multinomial logistic regression model was fit to data obtained from a product safety study wherein a broad sample class of women were tested. It was determined that a correlation existed between certain physical traits (factors) of the women and the product size each women chose to wear. A Spearman rank correlation was used to analyze the data to predict which factors best correlate to product size. The factors included age, weight, body mass index (BMI), and number of vaginal births. BMI and number of vaginal births were found to be a positive correlation factors in that as BMI and number of births increased, the preferred product size generally increased. Age was found to be a negative correlation factor in that as age increased, the preferred product size generally decreased.

The logit model was then fit to the data set using number of vaginal births, age, and weight to predict a product size for various combinations of the factors or variables of a single factor. The logit model used is set forth below:

$${π}_{j} ( {x}_{i} ) = \frac{exp ( {α}_{j} + {β}_{j} {x}_{i} )}{\begin{matrix}exp ( {α}_{small} + {β}_{small} {x}_{i} ) + exp ( {α}_{medium} + {β}_{medium} {x}_{i} ) + \\ exp ( {α}_{large} + {β}_{large} {x}_{i} )\end{matrix}}$$

where πᵢ(xᵢ) denotes the probability of product size j(j=“small”, “medium”, “large”) at the ith setting of factor x (xᵢ=x_{age}, x_{weight}, x_{BMI}, x_{number of vaginal births})

The coefficients αⱼ and βⱼ are maximum likelihood estimates, which are parameter values under which the observed data would have had the highest probability of occurrence. One parameter, for example, “small”, is set as a reference, so αₛₘₐₗₗ=βₛₘₐₗₗ=0.

It is within the scope and spirit of the invention to provide to consumers a usable data format wherein at least one wearer factor is correlated to product size. In a desirable embodiment, a plurality of factors are correlated to product size. The Tables below are examples of correlation between individual factors and product size, and a combination of factors and product size. The tables were derived in accordance with the logit model described above.

TABLE I
PROBABILITY OF PRODUCT SIZE BY AGE IN YEARS

| Age | ProbSmall | ProbMedium | ProbLarge |
|---|---|---|---|
| 12 | 0.265 | 0.533 | 0.202 |
| 13 | 0.266 | 0.533 | 0.201 |
| 14 | 0.267 | 0.532 | 0.201 |
| 15 | 0.268 | 0.531 | 0.201 |
| 16 | 0.269 | 0.530 | 0.201 |
| 17 | 0.270 | 0.529 | 0.201 |
| 18 | 0.271 | 0.528 | 0.201 |
| 19 | 0.273 | 0.527 | 0.201 |
| 20 | 0.274 | 0.526 | 0.200 |
| 21 | 0.275 | 0.525 | 0.200 |
| 22 | 0.276 | 0.524 | 0.200 |
| 23 | 0.277 | 0.523 | 0.200 |
| 24 | 0.278 | 0.522 | 0.200 |
| 25 | 0.279 | 0.521 | 0.200 |
| 26 | 0.280 | 0.520 | 0.199 |
| 27 | 0.281 | 0.520 | 0.199 |
| 28 | 0.282 | 0.519 | 0.199 |
| 29 | 0.284 | 0.518 | 0.199 |
| 30 | 0.285 | 0.517 | 0.199 |
| 31 | 0.286 | 0.516 | 0.199 |
| 32 | 0.287 | 0.515 | 0.198 |
| 33 | 0.288 | 0.514 | 0.198 |
| 34 | 0.290 | 0.513 | 0.198 |
| 35 | 0.290 | 0.512 | 0.198 |
| 36 | 0.291 | 0.511 | 0.198 |
| 37 | 0.292 | 0.510 | 0.197 |
| 38 | 0.294 | 0.509 | 0.197 |
| 39 | 0.295 | 0.508 | 0.197 |
| 40 | 0.296 | 0.507 | 0.197 |
| 41 | 0.297 | 0.506 | 0.197 |
| 42 | 0.298 | 0.505 | 0.197 |
| 43 | 0.299 | 0.504 | 0.196 |
| 44 | 0.300 | 0.503 | 0.196 |
| 45 | 0.302 | 0.502 | 0.196 |
| 46 | 0.303 | 0.501 | 0.196 |
| 47 | 0.304 | 0.500 | 0.196 |
| 48 | 0.305 | 0.500 | 0.195 |
| 49 | 0.306 | 0.499 | 0.195 |

As can be seen from Table I, for an age group of women between 12 years and 49 years, wherein age is the only variable factor, the most likely product size of choice for each year is “medium.” As age increases, however, the probability of “medium” tends to decrease and the probability of “small” tends to increase. The information in this Table may be compiled and presented to consumers in various ways to assist in product size selection based solely on age. For example, the information may be summarized or condensed into a chart or table wherein it is indicated that for ages 12 through 30 (by way of example only), there is a high probability that the proper size is “medium,” and that for ages 30 through 47, there is a lesser probability that the proper size is “medium” and that “small” may also be proper. The format may indicate that size “large” is not likely the proper size based solely on age.

TABLE II
PROBABILITY OF PRODUCT SIZE
BY WEIGHT IN POUNDS

| Weight | ProbSmall | ProbMedium | ProbLarge |
|---|---|---|---|
| 100 | 0.388 | 0.493 | 0.118 |
| 110 | 0.375 | 0.498 | 0.127 |
| 120 | 0.363 | 0.502 | 0.135 |
| 130 | 0.350 | 0.505 | 0.145 |
| 140 | 0.338 | 0.508 | 0.154 |
| 150 | 0.325 | 0.511 | 0.164 |
| 160 | 0.313 | 0.513 | 0.175 |
| 170 | 0.300 | 0.514 | 0.186 |
| 180 | 0.288 | 0.515 | 0.197 |
| 190 | 0.276 | 0.515 | 0.209 |
| 200 | 0.265 | 0.514 | 0.221 |
| 210 | 0.253 | 0.513 | 0.234 |
| 220 | 0.242 | 0.511 | 0.247 |
| 230 | 0.231 | 0.509 | 0.261 |
| 240 | 0.220 | 0.505 | 0.275 |
| 250 | 0.209 | 0.502 | 0.289 |

As can be seen from Table II, for various weights between 100 lbs. and 250 lbs. (by elements of 10 lbs.), wherein weight is the only variable factor, the most likely product size of choice for each weight is “medium.” As weight increases to about 200 lbs, the probability of “medium” tends to increase. However, as weight increases from 200 lbs. to 250 lbs., the probability of “medium” tends to decrease and the probability of “large” increase. The probability of “large” tends to increase consistently over the entire weight range. The information in this Table may be compiled and presented to consumers in various ways to assist in product size selection based solely on weight. For example, the information may be summarized or condensed into a chart or table wherein it is indicated that for weights between about 100 lbs. to about 200 lbs., there is a higher probability that the proper size is “medium,” a lesser probability that the proper size is “small,” and a least probability that the proper size is “large.” For weights in excess of about 200 lbs, there is a higher probability that the proper size is “medium”, but that this probability decreases in favor of “large” and weight further increases.

TABLE III
PROBABILITY OF PRODUCT SIZE
BY NUMBER OF VAGINAL BIRTHS

| VaginalBirths | ProbSmall | ProbMedium | ProbLarge |
|---|---|---|---|
| 0 | 0.355 | 0.508 | 0.137 |
| 1 | 0.313 | 0.515 | 0.172 |
| 2 | 0.273 | 0.515 | 0.213 |
| 3 | 0.234 | 0.507 | 0.259 |
| 4 | 0.198 | 0.491 | 0.311 |
| 5 | 0.164 | 0.469 | 0.367 |

As can be seen from Table II, for vaginal births between 0 and 5, wherein number of births is the only variable factor, the most likely product size of choice at each number of births is “medium.” However, as the number of births increases, the probability of “medium” decreases in favor of “large.” The information in this Table may be compiled and presented to consumers in various ways to assist in product size selection based solely on number of vaginal births. For example, the information may be summarized or condensed into a chart or table wherein it is indicated that for vaginal births of three or less, the most likely proper size is “medium.” As the number of births increases, however, the proper size may likely be “large.”

TABLE IV
PROBABILITY OF PRODUCT SIZE
BY BODY MASS INDEX (BMI)

| BMI | ProbSmall | ProbMedium | ProbLarge |
|---|---|---|---|
| 15 | 0.426 | 0.472 | 0.102 |
| 16 | 0.417 | 0.476 | 0.107 |
| 17 | 0.407 | 0.481 | 0.112 |
| 18 | 0.398 | 0.485 | 0.117 |
| 19 | 0.389 | 0.488 | 0.123 |
| 20 | 0.380 | 0.492 | 0.128 |
| 21 | 0.371 | 0.495 | 0.134 |
| 22 | 0.362 | 0.499 | 0.140 |
| 23 | 0.353 | 0.502 | 0.146 |
| 24 | 0.344 | 0.504 | 0.152 |
| 25 | 0.335 | 0.507 | 0.158 |
| 26 | 0.326 | 0.509 | 0.165 |
| 27 | 0.317 | 0.511 | 0.172 |
| 28 | 0.309 | 0.513 | 0.179 |
| 29 | 0.300 | 0.514 | 0.186 |
| 30 | 0.291 | 0.515 | 0.193 |
| 31 | 0.283 | 0.516 | 0.201 |
| 32 | 0.275 | 0.517 | 0.208 |
| 33 | 0.266 | 0.517 | 0.216 |
| 34 | 0.258 | 0.517 | 0.224 |
| 35 | 0.250 | 0.517 | 0.233 |
| 36 | 0.242 | 0.517 | 0.241 |
| 37 | 0.235 | 0.516 | 0.250 |
| 38 | 0.227 | 0.515 | 0.258 |
| 39 | 0.219 | 0.513 | 0.267 |
| 40 | 0.212 | 0.512 | 0.276 |
| 41 | 0.205 | 0.510 | 0.285 |
| 42 | 0.198 | 0.508 | 0.295 |
| 43 | 0.191 | 0.505 | 0.304 |
| 44 | 0.184 | 0.502 | 0.314 |
| 45 | 0.177 | 0.499 | 0.323 |

BMI is a factor of height and weight and is computed as follows:

In English units:

$$BMI = 703 * \frac{weight ( lbs )}{{[ height ( in ) ]}^{2}}$$

In metric units:

$$\begin{matrix}BMI = \frac{weight ( kg )}{{[ height ( m ) ]}^{2}} \\ BMI is expressed in kg \text{/} {m}^{2} .\end{matrix}$$

As can be seen from Table IV, for a BMI range between 15 to 45, the most likely product size is “medium.” As BMI increases from 15 to about 34, the probability of “medium” increases. As BMI increases from about 34 to about 45, the probability of “medium” decreases in favor of “large.” As BMI increases from 15 to 45, the probability of “small” decreases consistently. The information in this Table may be compiled and presented to consumers in various ways to assist in product size selection based solely on BMI.

TABLE V
PROBABILITY OF PRODUCT SIZE BY WEIGHT IN
POUNDS AND NUMBER OF VAGINAL BIRTHS

| Weight | VaginalBirths | ProbSmall | ProbMedium | ProbLarge |
|---|---|---|---|---|
| 100 | 0 | 0.446 | 0.471 | 0.082 |
| 100 | 1 | 0.404 | 0.491 | 0.105 |
| 100 | 2 | 0.362 | 0.505 | 0.133 |
| 100 | 3 | 0.321 | 0.514 | 0.165 |
| 100 | 4 | 0.280 | 0.516 | 0.203 |
| 100 | 5 | 0.242 | 0.512 | 0.247 |
| 120 | 0 | 0.421 | 0.484 | 0.095 |
| 120 | 1 | 0.379 | 0.501 | 0.120 |
| 120 | 2 | 0.337 | 0.512 | 0.150 |
| 120 | 3 | 0.297 | 0.518 | 0.186 |
| 120 | 4 | 0.257 | 0.516 | 0.227 |
| 120 | 5 | 0.220 | 0.507 | 0.273 |
| 140 | 0 | 0.396 | 0.496 | 0.108 |
| 140 | 1 | 0.354 | 0.510 | 0.136 |
| 140 | 2 | 0.313 | 0.518 | 0.169 |
| 140 | 3 | 0.273 | 0.519 | 0.208 |
| 140 | 4 | 0.235 | 0.513 | 0.252 |
| 140 | 5 | 0.199 | 0.500 | 0.301 |
| 160 | 0 | 0.371 | 0.506 | 0.123 |
| 160 | 1 | 0.330 | 0.516 | 0.154 |
| 160 | 2 | 0.289 | 0.521 | 0.190 |
| 160 | 3 | 0.250 | 0.518 | 0.232 |
| 160 | 4 | 0.214 | 0.508 | 0.279 |
| 160 | 5 | 0.179 | 0.491 | 0.330 |
| 180 | 0 | 0.346 | 0.514 | 0.140 |
| 180 | 1 | 0.305 | 0.521 | 0.174 |
| 180 | 2 | 0.266 | 0.521 | 0.213 |
| 180 | 3 | 0.228 | 0.514 | 0.257 |
| 180 | 4 | 0.193 | 0.500 | 0.307 |
| 180 | 5 | 0.161 | 0.479 | 0.360 |
| 200 | 0 | 0.322 | 0.520 | 0.158 |
| 200 | 1 | 0.282 | 0.523 | 0.195 |
| 200 | 2 | 0.243 | 0.520 | 0.237 |
| 200 | 3 | 0.207 | 0.509 | 0.284 |
| 200 | 4 | 0.174 | 0.490 | 0.336 |
| 200 | 5 | 0.144 | 0.466 | 0.391 |
| 220 | 0 | 0.298 | 0.524 | 0.178 |
| 220 | 1 | 0.259 | 0.524 | 0.218 |
| 220 | 2 | 0.222 | 0.516 | 0.263 |
| 220 | 3 | 0.187 | 0.501 | 0.312 |
| 220 | 4 | 0.156 | 0.478 | 0.366 |
| 220 | 5 | 0.128 | 0.451 | 0.422 |
| 240 | 0 | 0.274 | 0.526 | 0.199 |
| 240 | 1 | 0.237 | 0.521 | 0.242 |
| 240 | 2 | 0.201 | 0.509 | 0.290 |
| 240 | 3 | 0.168 | 0.490 | 0.342 |
| 240 | 4 | 0.139 | 0.465 | 0.397 |
| 240 | 5 | 0.113 | 0.434 | 0.454 |

Table V is an example of correlation of a combination of factors (weight and number of vaginal births) with product size. Each twenty pound weight increment between 100 pounds and 240 pounds is combined with vaginal births between 0 and 5. It should be appreciated from this Table that, as the number of factors analyzed increases, the number of potential combinations increases significantly (as a square function). It may be desired to summarize the resulting data format by trends, increased ranges (i.e, 40 lb. Increments or vaginal births as a factor of 2), and so forth, so that the data format can be readily incorporated with the product packaging. It is well within the level of skill of those in the art to analyze and compile the data into a format that is user-friendly while still providing the wearer with sufficient information to make an informed decision. Alternately, it may be desired to present the wearer with the complete compilation of data in, for example, a chart or table format in various media. The wearer would simply need to cross reference their respective combination of factors to determine the most probable product size selection.

TABLE VI
PROBABILITY OF PRODUCT SIZE BY AGE, WEIGHT IN
POUNDS, AND NUMBER OF VAGINAL BIRTHS

| Age | Weight | VaginalBirths | ProbSmall | ProbMedium | ProbLarge |
|---|---|---|---|---|---|
| 12 | 100 | 0 | 0.361 | 0.519 | 0.120 |
| 12 | 100 | 1 | 0.308 | 0.534 | 0.157 |
| 12 | 150 | 0 | 0.296 | 0.539 | 0.165 |
| 12 | 150 | 1 | 0.247 | 0.542 | 0.212 |
| 12 | 240 | 0 | 0.192 | 0.535 | 0.273 |
| 12 | 240 | 1 | 0.153 | 0.514 | 0.333 |
| 18 | 100 | 0 | 0.385 | 0.506 | 0.109 |
| 18 | 100 | 1 | 0.331 | 0.526 | 0.143 |
| 18 | 100 | 2 | 0.279 | 0.535 | 0.185 |
| 18 | 100 | 3 | 0.231 | 0.534 | 0.235 |
| 18 | 100 | 4 | 0.187 | 0.522 | 0.292 |
| 18 | 100 | 5 | 0.148 | 0.498 | 0.354 |
| 18 | 150 | 0 | 0.319 | 0.531 | 0.151 |
| 18 | 150 | 1 | 0.268 | 0.538 | 0.194 |
| 18 | 150 | 2 | 0.220 | 0.535 | 0.245 |
| 18 | 150 | 3 | 0.177 | 0.520 | 0.303 |
| 18 | 150 | 4 | 0.140 | 0.494 | 0.366 |
| 18 | 150 | 5 | 0.107 | 0.460 | 0.433 |
| 18 | 200 | 1 | 0.210 | 0.535 | 0.256 |
| 18 | 200 | 2 | 0.168 | 0.517 | 0.315 |
| 18 | 200 | 3 | 0.132 | 0.490 | 0.379 |
| 18 | 200 | 4 | 0.101 | 0.454 | 0.445 |
| 18 | 200 | 5 | 0.076 | 0.411 | 0.513 |
| 18 | 250 | 0 | 0.199 | 0.534 | 0.267 |
| 18 | 250 | 1 | 0.159 | 0.514 | 0.326 |
| 18 | 250 | 2 | 0.124 | 0.485 | 0.391 |
| 18 | 250 | 3 | 0.095 | 0.447 | 0.458 |
| 18 | 250 | 4 | 0.071 | 0.404 | 0.526 |
| 18 | 250 | 5 | 0.052 | 0.357 | 0.591 |
| 24 | 100 | 0 | 0.410 | 0.493 | 0.098 |
| 24 | 100 | 1 | 0.355 | 0.515 | 0.130 |
| 24 | 100 | 2 | 0.302 | 0.529 | 0.169 |
| 24 | 100 | 3 | 0.251 | 0.532 | 0.217 |
| 24 | 100 | 4 | 0.205 | 0.524 | 0.271 |
| 24 | 100 | 5 | 0.163 | 0.505 | 0.332 |
| 24 | 150 | 0 | 0.342 | 0.521 | 0.137 |
| 24 | 150 | 1 | 0.289 | 0.533 | 0.178 |
| 24 | 150 | 2 | 0.240 | 0.534 | 0.226 |
| 24 | 150 | 3 | 0.195 | 0.523 | 0.282 |
| 24 | 150 | 4 | 0.155 | 0.502 | 0.344 |
| 24 | 150 | 5 | 0.120 | 0.470 | 0.410 |
| 24 | 200 | 0 | 0.277 | 0.536 | 0.187 |
| 24 | 200 | 1 | 0.229 | 0.534 | 0.237 |
| 24 | 200 | 2 | 0.185 | 0.521 | 0.293 |
| 24 | 200 | 3 | 0.146 | 0.498 | 0.356 |
| 24 | 200 | 4 | 0.113 | 0.465 | 0.422 |
| 24 | 200 | 5 | 0.086 | 0.424 | 0.490 |
| 24 | 250 | 0 | 0.218 | 0.535 | 0.247 |
| 24 | 250 | 1 | 0.176 | 0.519 | 0.305 |
| 24 | 250 | 2 | 0.138 | 0.494 | 0.368 |
| 24 | 250 | 3 | 0.106 | 0.459 | 0.435 |
| 24 | 250 | 4 | 0.080 | 0.417 | 0.503 |
| 24 | 250 | 5 | 0.059 | 0.372 | 0.569 |
| 30 | 100 | 0 | 0.434 | 0.478 | 0.088 |
| 30 | 100 | 1 | 0.379 | 0.504 | 0.117 |
| 30 | 100 | 2 | 0.325 | 0.521 | 0.154 |
| 30 | 100 | 3 | 0.273 | 0.528 | 0.199 |
| 30 | 100 | 4 | 0.224 | 0.525 | 0.251 |
| 30 | 100 | 5 | 0.180 | 0.510 | 0.310 |
| 30 | 150 | 0 | 0.366 | 0.510 | 0.124 |
| 30 | 150 | 1 | 0.312 | 0.526 | 0.162 |
| 30 | 150 | 2 | 0.261 | 0.531 | 0.208 |
| 30 | 150 | 3 | 0.214 | 0.525 | 0.262 |
| 30 | 150 | 4 | 0.171 | 0.507 | 0.322 |
| 30 | 150 | 5 | 0.134 | 0.480 | 0.387 |
| 30 | 200 | 0 | 0.300 | 0.530 | 0.171 |
| 30 | 200 | 1 | 0.249 | 0.532 | 0.218 |
| 30 | 200 | 2 | 0.203 | 0.524 | 0.273 |
| 30 | 200 | 3 | 0.162 | 0.504 | 0.334 |
| 30 | 200 | 4 | 0.126 | 0.475 | 0.399 |
| 30 | 200 | 5 | 0.096 | 0.437 | 0.467 |
| 30 | 250 | 0 | 0.238 | 0.534 | 0.228 |
| 30 | 250 | 1 | 0.193 | 0.523 | 0.284 |
| 30 | 250 | 2 | 0.153 | 0.501 | 0.346 |
| 30 | 250 | 3 | 0.119 | 0.469 | 0.412 |
| 30 | 250 | 4 | 0.090 | 0.430 | 0.480 |
| 30 | 250 | 5 | 0.067 | 0.386 | 0.547 |
| 40 | 100 | 0 | 0.476 | 0.452 | 0.073 |
| 40 | 100 | 1 | 0.420 | 0.481 | 0.099 |
| 40 | 100 | 2 | 0.364 | 0.504 | 0.131 |
| 40 | 100 | 3 | 0.310 | 0.518 | 0.171 |
| 40 | 100 | 4 | 0.259 | 0.522 | 0.219 |
| 40 | 100 | 5 | 0.211 | 0.514 | 0.275 |
| 40 | 150 | 0 | 0.406 | 0.489 | 0.105 |
| 40 | 150 | 1 | 0.351 | 0.510 | 0.139 |
| 40 | 150 | 2 | 0.298 | 0.522 | 0.180 |
| 40 | 150 | 3 | 0.247 | 0.524 | 0.230 |
| 40 | 150 | 4 | 0.201 | 0.513 | 0.286 |
| 40 | 150 | 5 | 0.159 | 0.492 | 0.348 |
| 40 | 200 | 0 | 0.338 | 0.516 | 0.146 |
| 40 | 200 | 1 | 0.285 | 0.526 | 0.189 |
| 40 | 200 | 2 | 0.236 | 0.524 | 0.240 |
| 40 | 200 | 3 | 0.191 | 0.512 | 0.298 |
| 40 | 200 | 4 | 0.151 | 0.489 | 0.361 |
| 40 | 200 | 5 | 0.116 | 0.456 | 0.428 |
| 40 | 250 | 0 | 0.273 | 0.528 | 0.198 |
| 40 | 250 | 1 | 0.225 | 0.525 | 0.250 |
| 40 | 250 | 2 | 0.181 | 0.510 | 0.309 |
| 40 | 250 | 3 | 0.142 | 0.484 | 0.373 |
| 40 | 250 | 4 | 0.109 | 0.450 | 0.441 |
| 40 | 250 | 5 | 0.082 | 0.409 | 0.509 |
| 49 | 100 | 0 | 0.513 | 0.426 | 0.061 |
| 49 | 100 | 1 | 0.457 | 0.459 | 0.084 |
| 49 | 100 | 2 | 0.401 | 0.486 | 0.113 |
| 49 | 100 | 3 | 0.345 | 0.506 | 0.149 |
| 49 | 100 | 4 | 0.292 | 0.516 | 0.193 |
| 49 | 100 | 5 | 0.241 | 0.515 | 0.245 |
| 49 | 150 | 0 | 0.434 | 0.467 | 0.089 |
| 49 | 150 | 1 | 0.388 | 0.493 | 0.119 |
| 49 | 150 | 2 | 0.332 | 0.511 | 0.157 |
| 49 | 150 | 3 | 0.279 | 0.518 | 0.202 |
| 49 | 150 | 4 | 0.230 | 0.515 | 0.255 |
| 49 | 150 | 5 | 0.185 | 0.500 | 0.315 |
| 49 | 200 | 0 | 0.374 | 0.500 | 0.126 |
| 49 | 200 | 1 | 0.320 | 0.515 | 0.165 |
| 49 | 200 | 2 | 0.267 | 0.521 | 0.212 |
| 49 | 200 | 3 | 0.219 | 0.515 | 0.266 |
| 49 | 200 | 4 | 0.175 | 0.498 | 0.327 |
| 49 | 200 | 5 | 0.137 | 0.470 | 0.393 |
| 49 | 250 | 0 | 0.307 | 0.519 | 0.174 |
| 49 | 250 | 1 | 0.256 | 0.523 | 0.222 |
| 49 | 250 | 2 | 0.208 | 0.514 | 0.278 |
| 49 | 250 | 3 | 0.166 | 0.495 | 0.339 |
| 49 | 250 | 4 | 0.129 | 0.465 | 0.405 |
| 49 | 250 | 5 | 0.098 | 0.428 | 0.474 |

Table VI presents selected portions from a data format correlating the combination of age (by years between 12 and 49), weight (in 10 lb. increments between 100 lbs. and 250 lbs.), and number of vaginal births (0 to 5 births). It should be appreciated that the complete data compilation for all combinations of the variables is extensive and need not be presented herein for an appreciation of the invention. As discussed with respect to Table V, it may be desired to summarize the resulting data format by trends, increased ranges (i.e, 40 lb. increments or vaginal births as a factor of 2), and so forth, so that the data format can be readily incorporated with the product packaging. It is well within the level of skill of those in the art to analyze and compile the data into a format that is user-friendly while still providing the wearer with sufficient information to make an informed decision. Alternately, it may be desired to present the wearer with the complete compilation of data in, for example, a chart or table format in various media. The wearer would simply need to cross reference their respective combination of factors to determine the most probable product size selection.

In the situation wherein the possible combination of factors is extensive, it is contemplated that the data be presented or made available to consumers in a “remote” format. For example, the data format may be maintained in an interactive website wherein the consumer enters their unique combination of factors and is automatically presented with the most probable product size. An interactive kiosk or terminal may be provided at the point of purchase of the articles. In an alternate embodiment, the data format may be presented in a booklet or pamphlet form provided at the point of sale of the products. It should be appreciated that a countless number of possibilities exist within the scope of the invention for making the information available to consumers in a user-friendly and informative manner.

It should be appreciated by those skilled in the art that various modifications and variations may be made to the embodiments of the invention illustrated or described herein without departing from the scope and spirit of the invention as set forth in the appended claims and their equivalents.

What is claimed is:

1. A method for determining a proper size of interlabial absorbent article for a wearer, said method comprising:
correlating at least one wearer characteristic factor to varying product sizes of an interlabial absorbent article;
arranging the correlated factor and sizes into a data form wherein a wearer enters their respective factor to determine a correlated product size; and
providing the data form to the wearer prior to purchase of the absorbent article products.

2. The method as in claim 1, comprising correlating a plurality of the wearer characteristic factors to varying sizes of the interlabial absorbent article.

3. The method as in claim 1, wherein the wearer characteristic factor is any one of age, weight, body mass index, and number of vaginal births.

4. The method as in claim 1, comprising correlating a plurality of the wearer characteristic factors to varying sizes of the interlabial absorbent article, the plurality of factors being any combination of age, weight, body mass index, and number of vaginal births.

5. The method as in claim 1, comprising correlating the wearer characteristic factor to varying product sizes based on a statistical probability derived from empirical data.

6. The method as in claim 1, comprising correlating the wearer characteristic factor to varying product sizes based on direct empirical data.

7. The method as in claim 1, comprising providing the data form as a readable form on packaging associated with the absorbent article products.

8. The method as in claim 1, comprising providing the data form as a booklet or pamphlet-type format.

9. The method as in claim 1, comprising providing the data form in a media remote from a place of purchase of the absorbent article products.

10. The method as in claim 9, comprising providing the data form as an electronic data base wherein the wearer enters their particular characteristic factor and the correlated product size is automatically retrieved and presented to the wearer.

11. The method as in claim 10, wherein the data base is entered by the wearer via an internet website.

12. A method for determining a proper size of interlabial absorbent article for a wearer, said method comprising:
correlating a plurality of wearer characteristic factors know to have an effect on size an interlabial absorbent article worn by a wearer, the factors relating to inherent physical characteristics of potential wearers commonly known to women;
arranging the correlated factors and sizes into a data form wherein a wearer cross references their particular respective factors to determine a correlated product size; and
providing the data form to the wearer prior to purchase of the absorbent article products.

13. The method as in claim 12, wherein the wearer characteristic factors are any combination of age, weight, body mass index, and number of vaginal births.

14 A system for aiding consumers with selection of a proper size interlabial absorbent article product, said system comprising a data form having at least one wearer characteristic factor correlated to various interlabial product sizes, said data form arranged in a format wherein a wearer cross references their particular respective factor to determine a proper size product, said data form being presented in a media available to the wearer prior to purchase of the products.

15 The system as in claim 14, wherein said data form comprises a plurality of wearer characteristic factors correlated to varying sizes of the interlabial absorbent article product.

16. The system as in claim 15, wherein said wearer characteristic factors are any combination of age, weight, body mass index, and number of vaginal births.

17. The system as in claim 14, wherein said wearer characteristic factor is any one of age, weight, body mass index, and number of vaginal births.

18. The system as in claim 14, wherein said wearer characteristic factor is correlated to varying product sizes based on a statistical probability derived from empirical data.

19. The system as in claim 14, wherein said data form comprises a readable format provided with packaging associated with the absorbent article products.

20. The system as in claim 19, wherein said readable format is one of a chart, table, and graph.

21. The system as in claim 14, wherein said data form comprises format provided remote from a place of purchase of the absorbent article products.

22. The system as in claim 21, wherein said data form comprises an electronic data base wherein the wearer enters their particular characteristic factor and the correlated product size is automatically retrieved and presented to the wearer.

23. The system as in claim 22, wherein said data base is accessible via an internet website.
